(19) United States
(12) Patent Application Publication
(10) Pub. No.: US 2014/0078736 A1
(43) Pub. Date: Mar. 20, 2014

(54) High power LED apparatus attaches to heat conductive object

(71) Applicant: Taiming Chen, Fremont, CA (US)

(72) Inventor: Taiming Chen, Fremont, CA (US)

(21) Appl. No.: 13/622,002

(22) Filed: Sep. 18, 2012

(51) Int. Cl. F21V 29/00

(52) U.S. Cl. 362/249.02

(57) ABSTRACT

This is a high power LED apparatus comprised of high power LED that attach to heat conductive object or Plate. Apparatus has luminary and electrodes on base and away from heat conductive object. Apparatus has underbelly thermal stub to make contact with heat conductive object to dissipate heat. Apparatus also has attaching means to anchor to heat conductive object, said attaching mean maybe a bulge thermal stub locked into cavity of heat conductive object.

### FIELD OF THE INVENTION

The present invention relates, in general, to a high power Light Emitting apparatus and, more particular, this invention relates to a Light Emitting Diode(LED), attaching to a heat conductive objective.

### BACKGROUND OF THE INVENTION

1. Field of the Invention

The present invention relates generally to electrical device that generates heat, and more particularly to a high power light emitting diode, or LED chip incorporated with heat dissipation device (heat sink) for dissipating waste heat and keeping operation temperature low. The LED element used in present invention has body structure that is design to sit directly on heat conductive object.

2. Description of the Related Art

A number of different principles of LED devices have been developed over the years. Since LED operates the best at lower temperature and it has a luminary at top, many high power LEDs employ underbelly thermal pad to dissipate heat out of device into PCB and then eventually to a heat sink.

A conventional high power LED chip has a luminary at top side of device, an underbelly thermal pad to dissipate heat and few electrodes for conduct electricity or signal. Both thermal pad and electrode contacts are facing downward for easy connection to printed circuit board (PCB).

Typically path for waste heat of LED comes out of thermal pad goes in and through PCB then eventually goes into heat sink attaching at back of PCB. This conventional thinking of combining pre-made LED circuit board and pre-made heat sink method does not help reducing thermal path length; but increase both weight and cost.

### DESCRIPTION OF THE RELATED ART

A number of different principles of LED devices have been developed over the years. Since LED operates the best at lower temperature and it has a luminary at top, many high power LEDs employ underbelly thermal pad to dissipate heat out of device into PCB and then eventually to a heat sink.

A conventional high power LED chip has a luminary at top side of device, an underbelly thermal pad to dissipate heat and few electric contacts for conduct electricity.

Typically path for waste heat of LED comes out of thermal pad then goes in and through PCB then eventually goes into heat sink attaching at back of PCB. This conventional thinking of combining pre-made LED circuit board and pre-made heat sink method does not help reducing thermal path length; but increase both weight and cost.

U.S. Pat. No. 5,785,418 to Peter A. Hochstein describes a LED array attach to PCB and then to heat sink block to fast dissipate heat.

U.S. Pat. No. 7,227,750 to Bishou Chen, Sheng Li describes a LED module has pins to conduct heat to back of PCB.

U.S. Pat. No. 7,806,574 to Peter Van Laanen and Jeff Bisberg describes a LED base lighting system which dissipates heat through PCB and structure member.

U.S. Pat. No. 7,044,620 to Paul D. Van Duyn describes a LED lighting system which dissipate heat through high conductivity material and use a separated PCB with reversed mounting pad and traces.

application Ser. No. 12/928,644 from Taiming Chen (same Inventor) describes a LED LAMP comprising of modules with LEDs mounted on edge of plates.

### BRIEF SUMMARY OF THE INVENTION

The present invention comprises an improved light emitting device, such as a high power LED chip, the device is designed to easily mount directly on a high conductivity object such as metal plate with its underbelly thermal pad making direct contact to metal plate. Heat comes out of LED thermal pad goes direct into metal plate and eventually dissipate into surrounding air through surface area of metal plate.

Compare to conventional mounting method for heat generating device, the present invention does not mount on top of PCB via electrodes and thermal pad; the under side of present invention has only thermal unit to make contact and bounding with heat conductive object; all electronic contacts, such as electrodes, are away from the mounting area. The major functions of a Printed Circuit Board are to provide attachment and circuit contacts to components. Since bounding to heat conductive object already provide function of attachment, a rigid PCB is no longer needed.

### BRIEF DESCRIPTION OF THE DRAWINGS

FIG. 1 is a perspective view of a traditional LED device.

FIG. 2 is a sectional view of a traditional LED device mounted on PCB and corporate with heat sink.

FIGS. 3 and 4 are perspective views of a LED and a corporative PCB.

FIG. 5 is cancelled.

FIG. 6 is a perspective view, showing two LED, a corporative PCB and heat conductive object.

FIG. 7 is a perspective view of a present invention, showing two LED mounting on heat conductive object, with flexible wiring.

FIG. 8 is a perspective view of present inventions, LED with bulge heat stub.

FIG. 9 is a perspective view of present invention and heat conductive object.

FIG. 10 is a perspective view, showing two LED attach to a heat conductive object.

FIG. 11-14 are perspective views of present invention, LED with clamping walls to attach on edge of plate.

FIG. 15 is a perspective view of a present invention adaptor with traditional LED.

FIG. 16 is a perspective view of a present invention adaptor with traditional LED.

### DETAILED DESCRIPTION OF THE PREFERRED EMBODIMENT

Prior to proceeding to the more detailed description of the present invention, it should be noted that, for the sake of clarity and understanding, identical components which have identical functions have been identified with identical reference numerals throughout the several views illustrated in the drawing figures.

FIG. 1 shows a perspective view of a traditional LED chip that has luminary 1 on top of base 2, a thermal pad 3 and electrodes 4 and 5 are underneath the base.

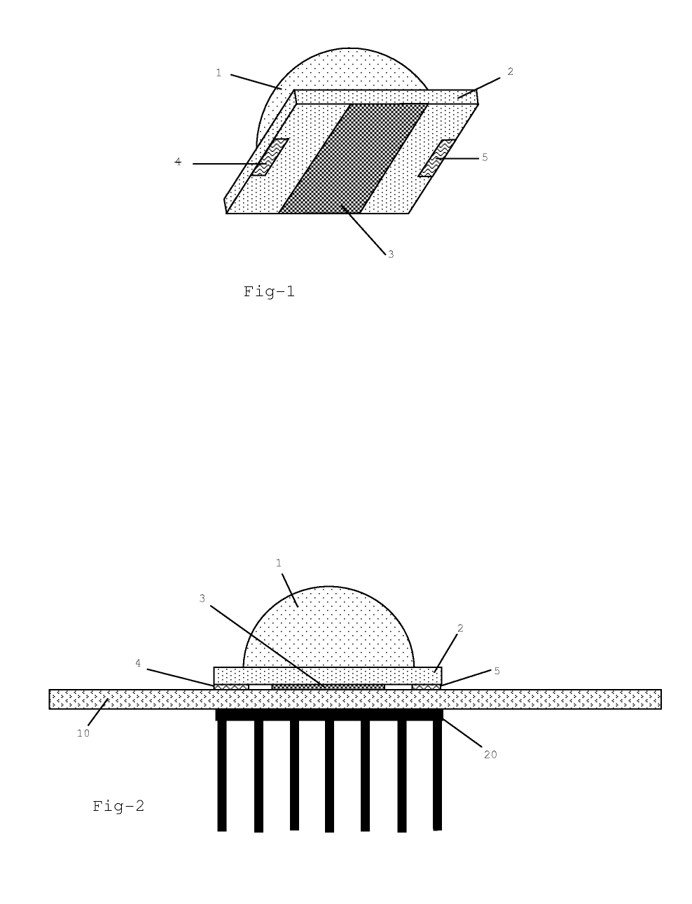

FIG. 2 shows a sectional view of traditional LED 2 mounted on top side of a PCB 10 and corporate with a heat sink 20 at the other side of PCB. Both electrodes and thermal pad of LED are connected toward PCB 10 at below.

FIG. 3 shows another perspective view of a LED 2 has only thermal pad 3 at underneath of LED base 2. A corporative PCB 10 with cut out 15 for exposing luminary 1. PCB 10 has contact points 11 and 12 facing downward to LED base 2.

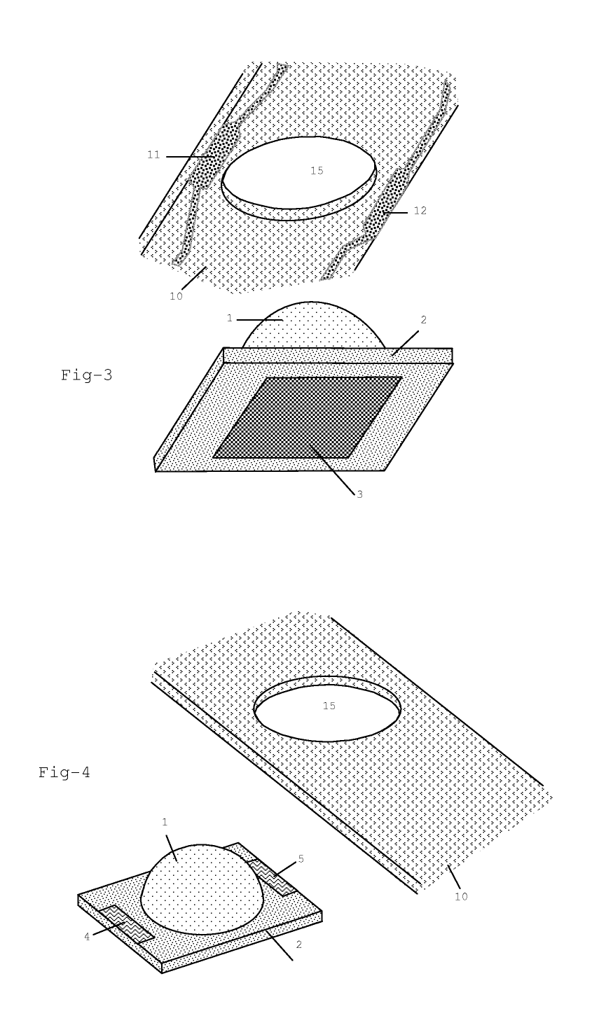

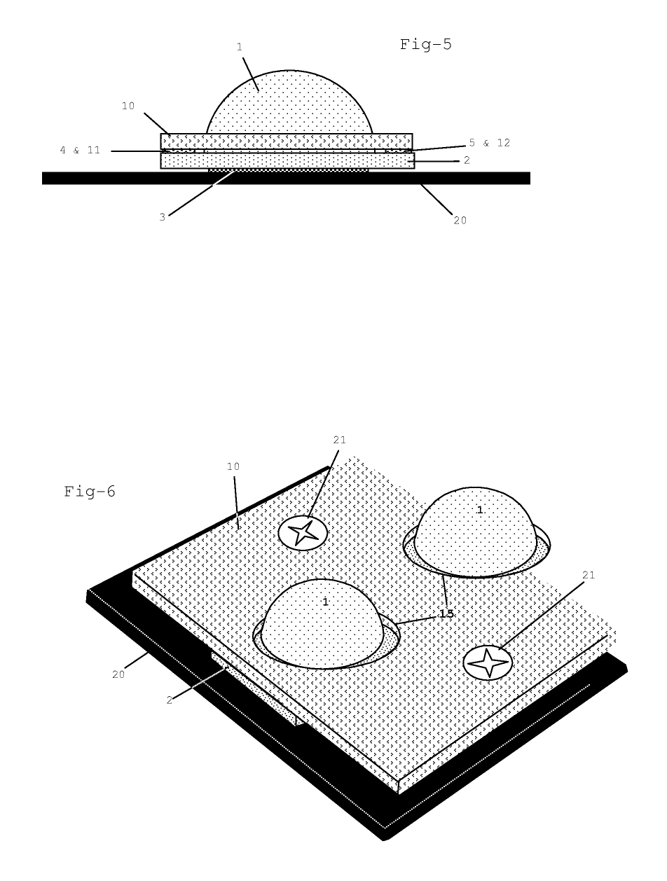

FIG. 4 shows another perspective view of a LED 2, same as FIG. 3. Wherein shows electrodes 4 and 5 at top side LED base 2. Electrodes 4 and 5 are facing upward toward PCB 10 from above.

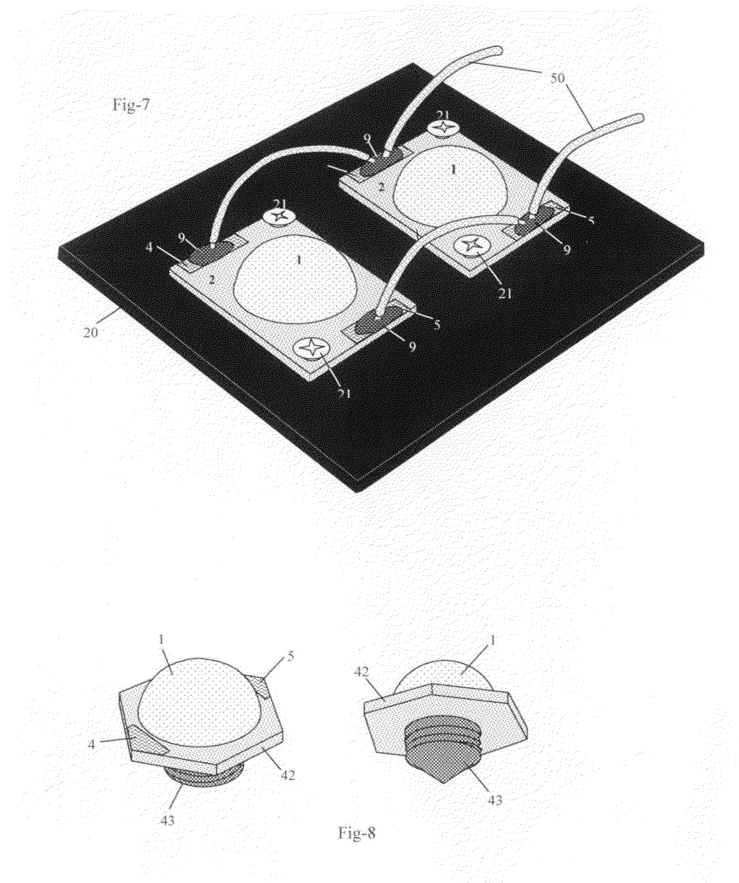

FIG. 5 is a cancelled.

FIG. 6 shows another perspective view of a example, showing at least two LED luminaries 1, sharing one PCB 10 and one heat conductive object 20. PCB 10 is fasten by two screws 21 on to heat conductive object 20 and can be used to hold down LED 1.

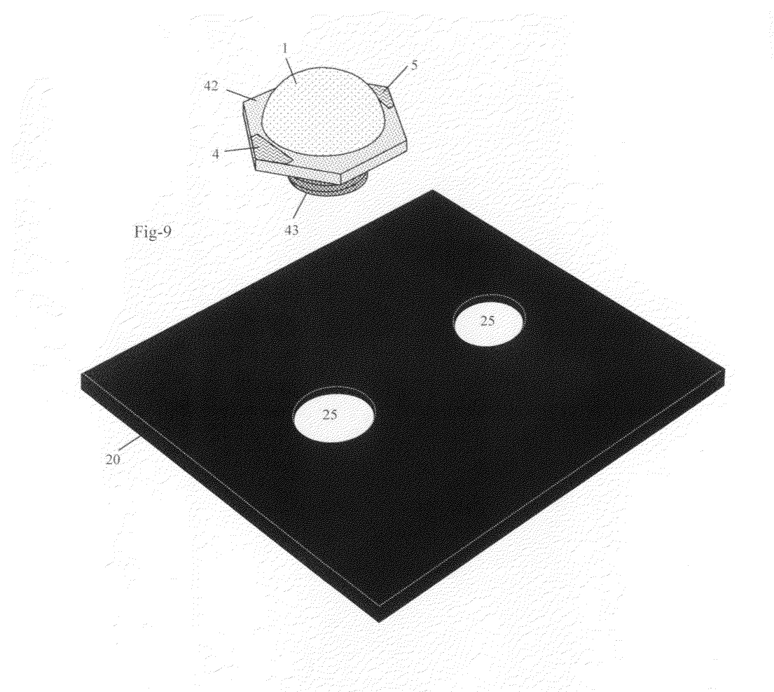

FIG. 7 shows a perspective view of two LED 2 mounted on top of a heat connective object 20 with screws 21. Circuitry is provided by electrical wires 50 solder on electric contacts 4,5. Electric contacts 4, 5 are away from heat conductive object 20.

FIG. 8 shows a perspective view of two instances of presenting invention, each LED comprising of a LED luminary 1, a main body structure 42, an penetrative thermal stub 43 underneath the body structure 42 for entering and anchoring to heat conductive object 20, two electric contacts 4, 5 are at up side of main body structure 42.

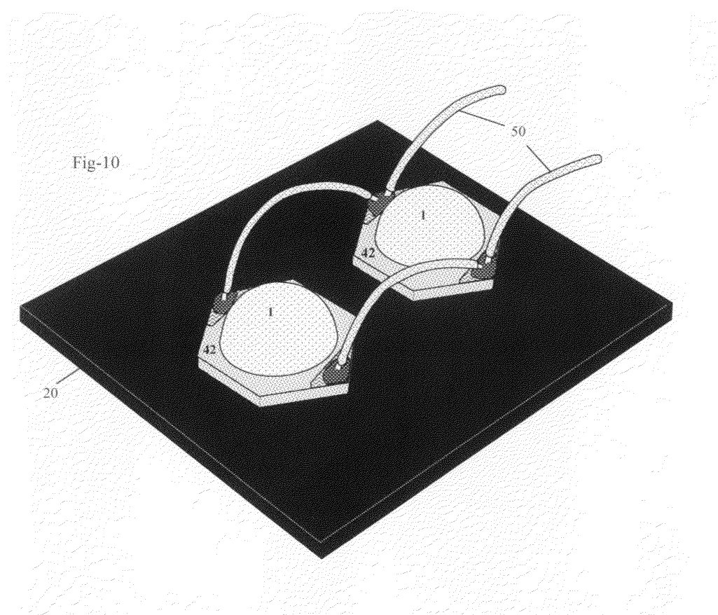

FIG. 9 shows a perspective view of presenting invention and a heat conductive object with two pre-drilled pilot holes 25 to accept penetrative thermal stub 43. Thermal stub 43 may have screw thread to bite into edge of hole 25 or just fasten with friction force to hole 25 wall tightly.

FIG. 10 shows a perspective view of two presenting LED 42 bound on top of a heat conductive object. Circuitry are connected by flexible wires 50.

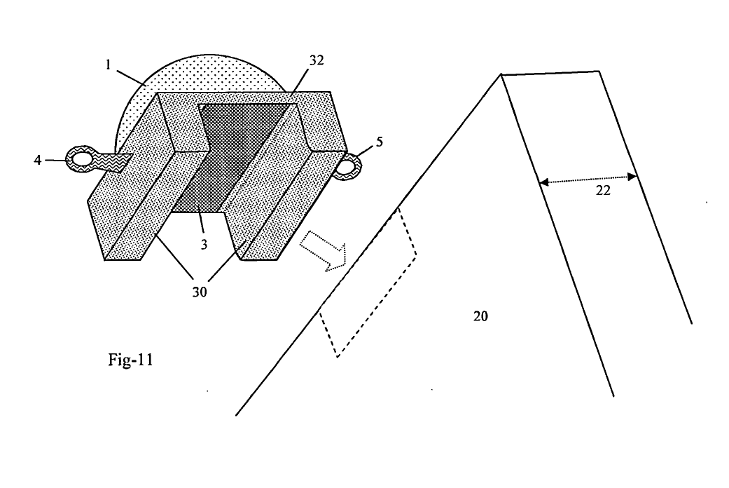

FIG. 11 shows a perspective view of a present invention comprising of a LED luminary 1, a main body structure 32, a thermal pad 3 is underneath the body 32, two electric contact 4, 5 and two clamping walls 30. Clamping walls 30 are to clamp on both side surfaces of a matching plate 20. Matching plate 20 has two large side surfaces and narrower edge surface 22 around said side surfaces. Electric contacts 4,5 are away from matching plate 20.

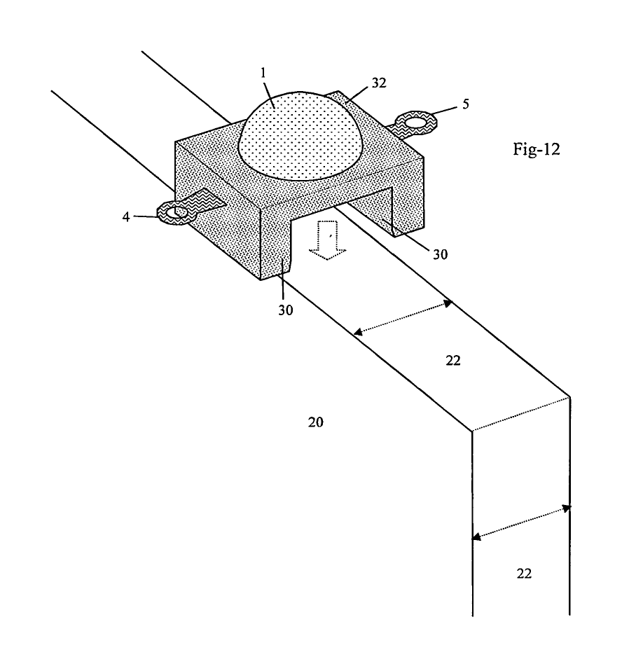

FIG. 12 shows another perspective view of present invention same as in FIG. 8. When this improved LED device 32 goes down to clamp at edge of matching plate 20, underneath thermal pad 3 would made direct contact with edge surface 22 of a plate. The clamping would work best when plate has matching thickness close to distance between two clamping walls 30 of said LED device 32.

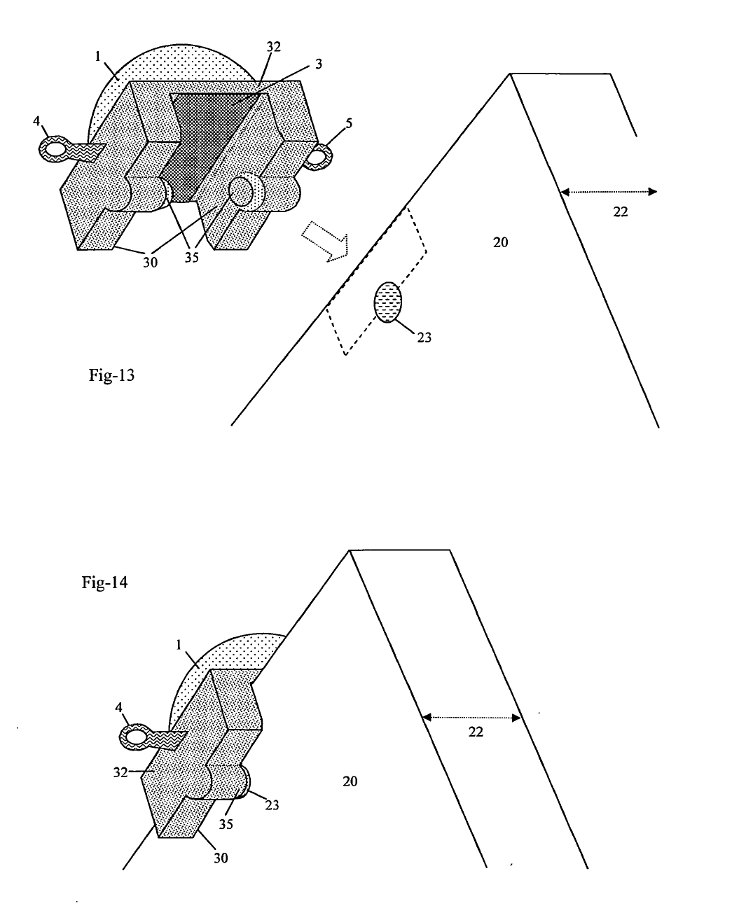

FIG. 13 shows a perspective view of a present invention, similar to FIGS. 8 and 9; in additional the device 32 has snap bumps 35 alongside of clamping wall 30; the plate 20 has matching notch hole 23 for accepting snap bumps 11. When bump snap 35 is actuated with notch hole 23, the device 32 is held at desired position.

FIG. 14 is another view of a present invention same as in FIG. 10. Wherein the device's snap bumps 35 actuated into notch holes 23 to hold the device 32 in position.

FIG. 15 is a perspective view of a present invention; where an adaptor device has body structure 33 is designed to work with a traditional LED device 2 same as in FIG. 1. Adaptor 33 has groove channels 31 to accept base 2 of LED. Once adaptor 33 is integrated with LED device 2, adaptor device 33 has two clamping walls 30 to clamp on both side surfaces of a matching plate 20 and position LED 2 to sit on the edge surface 22 of plate.

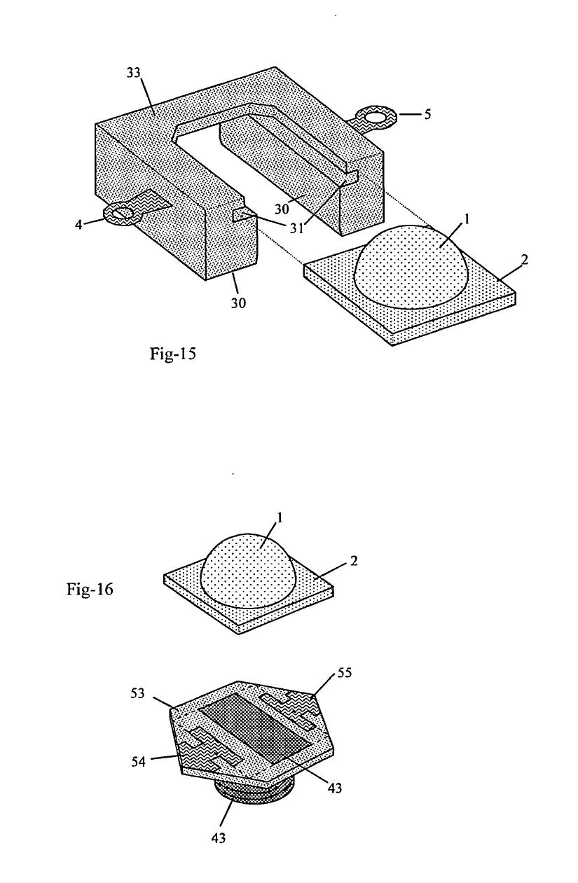

FIG. 16 is a perspective view of a present invention; where an adaptor device 53 is designed work with a traditional LED 2 same as FIG. 1. Said adaptor device has a hex nut shape base 53 and bulge thermal stub 43 extend from under said base 53 to top side of base to make contact with thermal pad 3 of a traditional LED 2. Said base 53 also has electrodes 54,55 to make contact with electrodes 4, 5 of traditional LED 2.

1. A light emitting device to attach on heat conductive object, said heat emitting device comprising:
a base body,
a plurality of luminaries at top side of said base to emit light,
at least one bulge thermal stub at under side of said base body to enter cavity of said heat conductive object for anchoring and to dissipate heat into said heat conductive object, and
a plurality of electrodes on said base body and away from said heat conductive object for conducting isolated electricity or signals.

2. A light emitting device of claim 1, wherein said thermal stud has helical screw thread for binding with said heat conductive object.

3. A light emitting device of claim 1, wherein said base has shape of screw head for accessing by wrench tool.

4. A light emitting device of claim 1, wherein said light emitting device can be separated into an adaptor portion of base contain said bulge thermal stub and a top portion contain said luminaries.

5. A heat generating electronic device to attach on edge of a heat conductive plate with matching thickness, said device comprising:
at least one heat source when powered,
a body structure contains said heat source,
at least one thermal pad on one side of said body structure to dissipate heat, and
two clamping walls to embrace on both opposite side surfaces of said heat conductive plate and to position said thermal pad to contact with said matching plate.

6. A heat generating electronic device of claim 5, wherein said heat source is Light Emitting Diode (LED).

7. A heat generating electronic device of claim 5, wherein adhesive is applied between said clamping walls and side surfaces of said matching plate.

8. A heat generating electronic device of claim 5, wherein said device attach to heat conductive plate by friction force between said clamping walls and side surfaces of said matching plate.

9. A heat generating electronic device of claim 5, wherein as least one position latching mean is used to fix position of said device on a matching plate.

10. A heat generating electronic device of claim 9, wherein said position latching mean comprising:
at least one notch dent on one side surface of said matching plate to receive stick out snap bump from said device, and
at least one stick out snap bump on said clamping wall to create a uneven contact between said clamping wall surface and side surface of said matching plate everywhere except when said snap bump actuated into said notch dent of matching plate.

11. A heat generating electronic device of claim 5, wherein said device body structure can be separated into one adaptor portion with two clamping walls and another heat generating portion contains said heat source and said thermal pad.
